(19) United States
(12) Patent Application Publication
(10) Pub. No.: US 2023/0319684 A1
(43) Pub. Date: Oct. 5, 2023

(54) RESOURCE FILTER FOR INTEGRATED NETWORKS

(71) Applicant: Comcast Cable Communications, LLC, Philadelphia, PA (US)

(72) Inventors: Ana Lucia Pinheiro, Allen, TX (US); Robert Jaksa, Irving, TX (US); Samian Kaur, Plymouth Meeting, PA (US)

(21) Appl. No.: 18/193,400

(22) Filed: Mar. 30, 2023

Related U.S. Application Data
(60) Provisional application No. 63/325,397, filed on Mar. 30, 2022.

(51) Int. Cl. H04W 48/02

(52) U.S. Cl. CPC H04W 48/02

(57) ABSTRACT

Disclosed is a method. The method may include receiving a policy for filtration of resources. The policy may be applied to a first path comprising a first network and a second path comprising a second network. The method includes receiving, from a user device based on the first path, a first request for a first resource, and the method includes determining, based on the first resource and the application of the policy, to impede access to the first resource.

### CROSS-REFERENCE TO RELATED APPLICATIONS

This application claims the benefit of U.S. Provisional Application No. 63/325,397, filed Mar. 30, 2022, which is incorporated herein in its entirety.

### BACKGROUND

Network operators provide access to networks and the Internet. Some network operators may provide multiple types of services for access. For example, a multiple service operator (MSO) may provide access through both Wi-Fi (e.g., IEEE 802.11 based protocols) access points and cellular nodes (e.g., 3GPP 5G Node B). A mobile network operator (MNO) may provide access to networks and the Internet through cellular nodes. User equipment (e.g., a user device) may be configured to communicate over one or more of these networks and resources may be accessible by one or more of the networks that are unapproved.

### SUMMARY

It is to be understood that both the following general description and the following detailed description are exemplary and explanatory only and are not restrictive.

User mobility allows users to connect with multiple networks to access resources available on the Internet or otherwise. Restrictions to access of certain resources may prompt users to access other networks to avoid such restrictions. A policy manager may be used to distribute policies to a resource filter to restrict access to resources. Access may be restricted based on categorical classification of the resource, attributes of the resource, or otherwise.

A resource may be accessed over multiple paths. For example, accessibility of a resource may be improved using a multipath protocol that accesses a particular resource over more than one network. Access restriction to multipath communications may be performed through a policy distributed and applied by one or more resource filters. The policy may be specific to the network, network nodes, a location of the network, or otherwise.

### BRIEF DESCRIPTION OF THE DRAWINGS

In order to provide understanding techniques described, the figures provide non-limiting examples in accordance with one or more implementations of the present disclosure, in which:

FIG. 1 illustrates an example system in accordance with one or more implementations of the present disclosure;

FIG. 2 illustrates an example architecture in accordance with one or more implementations of the present disclosure;

FIG. 3 illustrates an example communication path in accordance with one or more implementations of the present disclosure;

FIG. 4 illustrates an example method in accordance with one or more implementations of the present disclosure;

FIG. 5 illustrates an example method in accordance with one or more implementations of the present disclosure;

FIG. 6 illustrates an example architecture in accordance with one or more implementations of the present disclosure;

FIG. 7 illustrates an example architecture in accordance with one or more implementations of the present disclosure;

FIG. 8 illustrates an example architecture in accordance with one or more implementations of the present disclosure;

FIG. 9 illustrates an example architecture in accordance with one or more implementations of the present disclosure; and

FIG. 10 illustrates an example method in accordance with one or more implementations of the present disclosure.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. When values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude other components, integers or steps. “Exemplary” means “an example of” and is not intended to convey an indication of a preferred or ideal configuration. “Such as” is not used in a restrictive sense, but for explanatory purposes.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

This detailed description may refer to a given entity performing some action. It should be understood that this language may in some cases mean that a system (e.g., a computer) owned and/or controlled by the given entity is actually performing the action.

As will be appreciated by one skilled in the art, hardware, software, or a combination of software and hardware may be implemented. Furthermore, the methods and systems may take the form of a computer program product on a computer-readable storage medium (non-transitory) having processor-executable instructions (e.g., computer software) embodied in the storage medium. Any suitable computer-readable storage medium may be utilized including hard disks, CD-ROMs, optical storage devices, magnetic storage devices, memresistors, Non-Volatile Random Access Memory (NVRAM), flash memory, or a combination thereof.

Throughout this application reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a special purpose computer or other programmable data processing instrument to produce a machine, such that the processor-executable instructions which execute on the computer or other programmable data processing instrument create a device for implementing the steps specified in the flowchart block or blocks.

These processor-executable instructions may also be stored in a non-transitory computer-readable memory or a computer-readable medium that may direct a computer or other programmable data processing instrument to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing instrument to cause a series of operational steps to be performed on the computer or other programmable instrument to produce a computer-implemented process such that the processor-executable instructions that execute on the computer or other programmable instrument provide steps for implementing the functions specified in the flowchart block or blocks.

Blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

The method steps recited throughout this disclosure may be combined, omitted, rearranged, or otherwise reorganized with any of the figures presented herein and are not intend to be limited to the four corners of each sheet presented.

The techniques disclosed herein may be implemented on a computing device in a way that improves the efficiency of its operation. As an example, the methods, instructions, and steps disclosed herein improve the functioning of a computing device.

Filtering of resources (e.g., content or content access) protects individuals from accessing content that is not appropriate for their age or environment (e.g. work or school), reduces potential malware exposures by restricting access to malicious websites and email messages, and reduces network bandwidth use by restricting users from accessing unauthorized social media and streaming services. Content filtering may focus on singular communication paths such as home Internet access, enterprise Internet access, or mobile data access. It is becoming more common for individuals to have devices that can access content and services from a multitude of communication mediums. Consequently, if an individual cannot obtain unauthorized content across one access network, they may try an alternative access network, on purpose or by accident, and thus, bypass the intent of the filtering.

User mobility allows users to connect with multiple networks to access resources available on the Internet or otherwise. Restrictions to access of certain resources may prompt users to access other networks to avoid such restrictions. For example, a user device may have restrictions to access resources related to entertainment or gaming while on a home network or a school network. The user device may be configured to access those resources using a cellular network or another network, circumventing the resource restrictions.

A policy manager may be used to distribute policies to a resource filter to restrict access to resources equally over different networks. For example, a first network may be operated by a first network operator and a second network may be operated by a second network operator. The first network operator may restrict access to different resources than the second network operator. The policy manager may send a policy or apply a policy specific to one or more of the networks. For example, the policy may be based on a throughput of the network such that access to certain types of resources are unavailable. The policy may be specific to the type of traffic. For example, one or more paths of multipath traffic may be restricted based on the network designation or type of network. Traffic associated with a path traversing an interworking function may have less resource-based restrictions than traffic associated with a path traversing a node B. A resource filter may apply or enforce such restrictions.

Policies may be global. For example, the policies may prohibit Internet access after 10 PM. Policies may be local or network-specific. For example, policies may prohibit aggregate Internet communications over five Gigabytes. The policies may be stacked and applied by different filters. For example, all traffic over multiple paths may be forwarded to the global policy and local networks may apply the network-specific policy. A local policy may be used to override a global policy. For example, a message may be sent from the local filter to the global filter to ensure access to a resource is allowed that may otherwise conflict with the global policy. For example, a global policy may prohibit access to resources that contain or are related to nudity. A local policy for a network (e.g., a network specific policy) may override the global policy through a policy. For example, the network may be related to or provide access to resources for an anatomy class and the access of user devices to that network may allow access to nudity, while access from other networks may still be restricted from accessing resources with nudity by the global policy or global filter. The local filter or policy may be related to a key or another implement for signing permission to override the global policy. For example, communication that should override the global policy may be verified by the global filter based on the key (e.g., public key verification of the local policy private key).

A multipath connection may be created to establish a constant connection with application servers while allowing connections to cellular nodes and other access points without requiring new connections to be established. For example, a connection or session may be established with a computing device or application server based on an identifier and a subscription. Additional subflows may be generated for each cellular node or access point available based on the identifier and subscription. For example, three or four subflows or paths may be used.

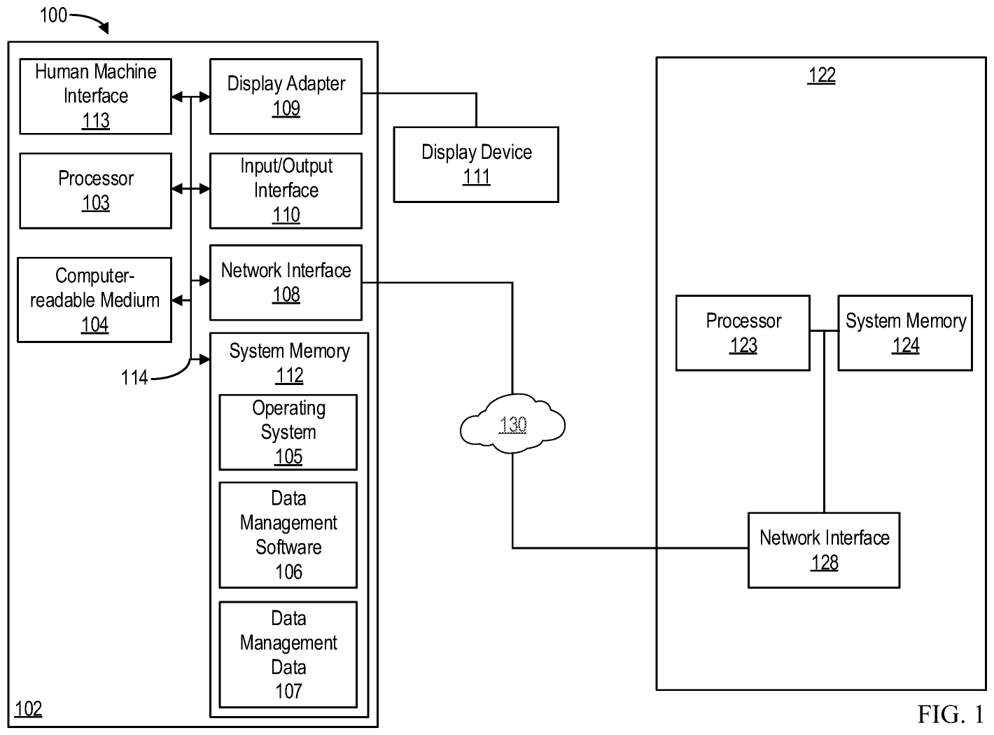

FIG. 1 shows an example system 100 in accordance with one or more applications of the present disclosure. The user device 102 may comprise one or more processors 103, a system memory 112, and a bus 114 that couples various components of the user device 102 including the one or more processors 103 to the system memory 112. In the case of multiple processors 103, the user device 102 may utilize parallel computing.

The bus 114 may comprise one or more of several possible types of bus structures, such as a memory bus, memory controller, a peripheral bus, an accelerated graphics port, and a processor or local bus using any of a variety of bus architectures.

The user device 102 may operate on and/or comprise a variety of user device readable media (e.g., non-transitory). User device readable media may be any available media that is accessible by the user device 102 and comprises, non-transitory, volatile and/or non-volatile media, removable and non-removable media. The system memory 112 has user device readable media in the form of volatile memory, such as random access memory (RAM), and/or non-volatile memory, such as read only memory (ROM). The system memory 112 may store data such as data management data 107 and/or programs such as operating system 105 and data management software 106 that are accessible to and/or are operated on by the one or more processors 103.

The user device 102 may also comprise other removable/non-removable, volatile/non-volatile user device storage media. For example, the user device 102 may include computer-readable medium 104. The computer-readable medium 104 may provide non-volatile storage of user device code, user device readable instructions, data structures, programs, and other data for the user device 102. The computer-readable medium 104 may be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Any number of programs may be stored on the computer-readable medium 104. An operating system 105 and software 106 may be stored on the computer-readable medium 104. One or more of the operating system 105 and software 106 (e.g., mobile applications), or some combination thereof, may comprise program and the software 106. Data management data 107 may also be stored on the computer-readable medium 104. Data management data 107 may be stored in any of one or more databases known in the art. The databases may be centralized or distributed across multiple locations within the network 130.

A user may enter commands and information into the user device 102 via one or more input devices. The input devices may comprise, but are not limited to, a keyboard, pointing device (e.g., a computer mouse, remote control), a microphone, a joystick, a scanner, tactile input devices such as gloves, and other body coverings, motion sensors, and the like. These and other input devices may be connected to the one or more processors 103 via a human machine interface 113 that is coupled to the bus 114. In an example, the one or more processors may be connected to the bus 114 iva other interface and bus structures, such as a parallel port, game port, an IEEE 1394 Port (also known as a Firewire port), a serial port, network interface 108, and/or a universal serial bus (USB).

A display device 111 may also be connected to the bus 114 via an interface, such as a display adapter 109. In an example, the user device 102 may have more than one display adapter 109 and the user device 102 may have more than one display device 111. A display device 111 may be a monitor, an LCD (Liquid Crystal Display), light emitting diode (LED) display, television, smart lens, smart glass, and/or a projector. In addition to the display device 111, other output peripheral devices may comprise components such as speakers and a printer which may be connected to the user device 102 via an Input/Output Interface 110. Any step and/or result of the methods may be output (or caused to be output) in any form to an output device. Such output may be any form of visual representation, including, but not limited to, textual, graphical, animation, audio, tactile, and the like. The display device 111 and the user device 102 may be configured as one device, or separate devices.

The user device 102 may operate in a networked environment using logical connections to one or more computing devices 122. A computing device 122 may be a personal computer, computing station (e.g., workstation), portable computer (e.g., laptop, mobile phone, tablet device), smart device (e.g., smartphone, smart watch, activity tracker, smart apparel, smart accessory), security and/or monitoring device, a server, a router, a network computer, a peer device, edge device or other common network node, and so on. Logical connections between the user device 102 and a computing device 122 may be made via a network 130. Such network connections may be through a network interface 108. A network interface 108 may be implemented in both wired and wireless environments.

Application programs and other executable program components such as the operating system 105 are shown herein as discrete blocks, although it is recognized that such programs and components may reside at various times in different storage components of the user device 102, and are executed by the one or more processors 103 of the user device 102. The computing device 122 may include all of the components described with regard to the user device 102.

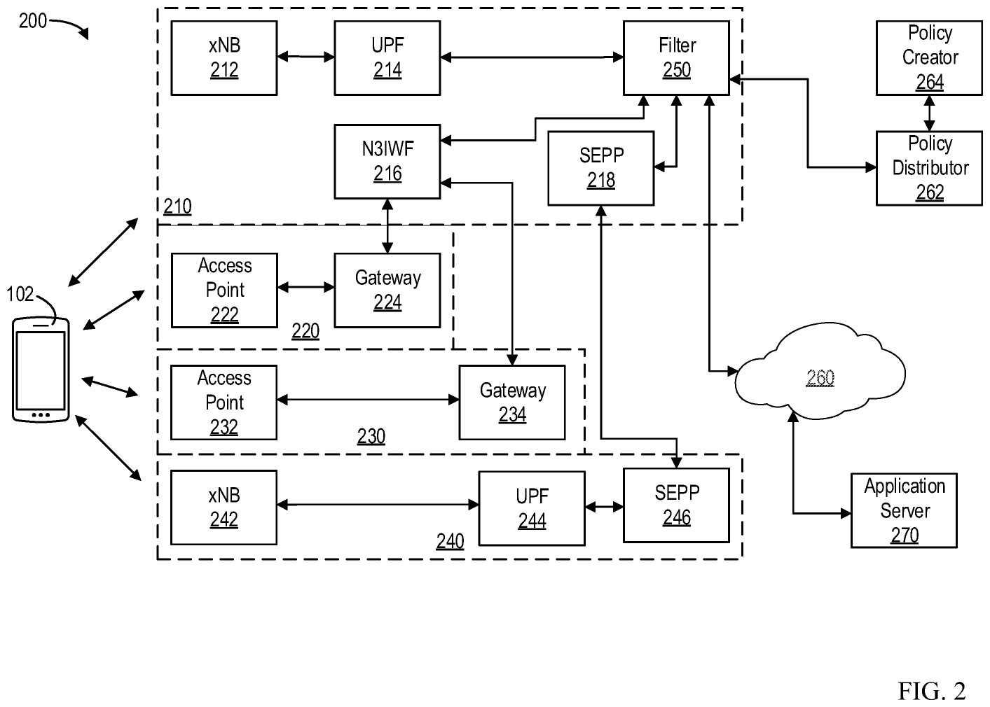

The user device 102 may comprise one or more components configured to communicate over electromagnetic waves or other mediums. The user device 102 may be configured with one or more subscriber identity modules (SIM). The SIM may be stored in persistent memory, embedded, physical, or combinations thereof. In such a way, the SIM may form a credential circuit as data stored permanently or otherwise on the user device 102. The SIM may be configured for Dual SIM Dual Standby (DSDS). For example, the primary SIM of the DSDS may be a physical SIM (pSIM) and the secondary SIM may be an embedded SIM (eSIM). The SIM may include one or more pairs of unique identifiers and keys. Information may be stored on a particular chip or combinations of chips, the computer-readable medium 104, or otherwise. The user device 102 may further comprise a filter 250, as shown in FIG. 2, for example.

The user device 102 may be configured to communicate over a network interface 108. The network interface 108 may be configure with a radio or other electromagnetic spectrum transceiver. The network interface 108 may be combined with a SIM, and identification numbers (e.g., international mobile subscriber identity, local area identity) and keys therein (e.g., kᵢ), for secure communications.

The user device 102 may communicate with the computing device 122 via a network 130. Such communication paths may include wired communication technologies, wireless communication technologies, or combinations thereof. Wireless communication technologies may include various 3GPP standards (e.g., LTE, 5G) and Institute of Electrical and Electronics Engineers (IEEE) standards (e.g., 802.11). Wired communication technologies may include various IEEE standards (e.g., 802.3). While various communication technologies and standards are contemplated herein, various communication mediums (e.g., wire, air), standards making bodies (e.g., 3GPP, IETF, IEEE), and protocols are contemplated herein.

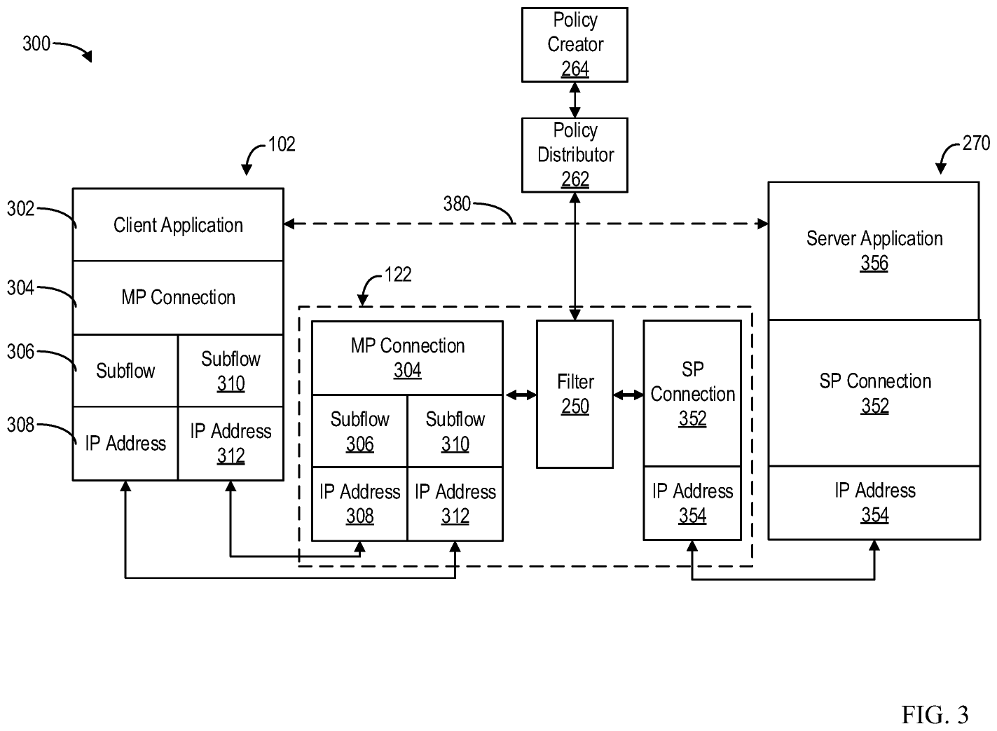

Communications protocols contemplated herein may be connectionless or connection-based. For example, Transmission Control Protocol (TCP) may be used to establish state-based or connection-based communication between a client (e.g., user device 102), a computing device 122, or components, hops, nodes, instances, functions there between, or combinations thereof. A protocol may define header and payload information for packets of information. Headers may define various configurations and settings associated with the transmitted payload. The computing device 122 may include instructions to execute a transport converter 380, as shown in FIG. 3, for example, and the computing device 122 may be one or more devices implemented to perform any of the steps or operations described herein.

FIG. 2 shows an example architecture 200 in accordance with one or more implementations of the present disclosure. A network 210 (e.g., a network of a first network operator) may include wireless communication protocols between a user device 102 and the cellular base station 212 (e.g., eNB, gNB, xNB), which may be part of a radio access network based on various radio access technologies. The radio access network may be associated with a network. A network (e.g., public land mobile network (PLMN)) may maintain the radio access network and the associated core network, which may include the user plane function 214, network interworking function 216, security edge protection proxy 218, and other components. The operator of network 210 may issue subscriptions for the user device 102 to access the network 210. The network may include communications hardware and software to support various protocols and components (e.g., 3GPP 5G, IEEE 802.11). The terms provided above (e.g., PLMN) and other operator indicators are intended for designation (e.g., first, second, third) to distinguish between different networks and are not intended to be rigid as terminology and scope of these and other terms is evolving in the field.

Another communication path may be established between user device 102 and computing device 122 over a network 220 (e.g., a network of a second network operator or a different access node of the first network operator) having a Wi-Fi or IEEE 802.11 access point 222. The access point 222 may be configured to communicate with a wireless access gateway 224. The wireless access gateway 224 may route data packets from the access point 224 to the network 210. An operator of the network 220 may maintain the access point 222 and the associated wireless access gateway 224. The network may issue subscriptions for the user device 102 to access one or more of the networks (e.g., network 210, 220, 230, 240). The subscriptions may be issued in packages (e.g., subscription packages) and stored or unpacked on a SIM, an embedded SIM, or otherwise. The network associated with the access point 222 may be different than the network associated with the radio access network.

The core network of network 210 and wireless access gateway 224 are used as examples for context. It should be appreciated that standards may change the names of these entities as technologies improve and progress. The core network 230 and the wireless access gateway 224 may be configured to directly communicate over an interface. For example, an access and mobility function (AMF), or user plane function (UPF) may perform some or all of the steps described herein. The computing device 122 may be configured to perform all or some of the steps described. For example, the computing device 122 may filter resources accessible by the user device 102.

Additional networks 230, 240 may be available to the user device 102. The network 230 may be similar to that of network 220, where the network 230 includes an access point 232 and a gateway 234. For example, the network 220 may be public network accessible to user devices 102 having a subscription to access the network, while the network 230 may be a home network accessible to user devices 102 within an effective range of the access point 232. The access point 222 may be implemented unitarily with the access point 232 in that they have a common housing, transceiver, or other component in common. Network 240 may be similar to that of network 210, wherein the network 240 may include a base station 242 and user plane function 244. Internetwork communications may be performed between SEPP 218 and SEPP 246.

The computing device 122 may be associated, or integrated, with one or more of the networks 210, 220, 230, 240. The computing device 122 may be independent of the networks 210, 220, 230, 240 and may be disposed on another network or the cloud. For example, the computing device 122 may be configured as an intermediary, wherein the computing device 122 may be configured to receive data from the user device 102 via any of the networks 210, 220, 230, 240 or another network and restrict access to one or more resources otherwise available.

The computing device 122 may include instructions to serve as a proxy or proxy server (e.g., an MPTCP proxy, an MPDCCP proxy, an MPQUIC proxy) for the plurality of paths formed between application server 270 and user device 102. For example, one or more application servers 270 may be configured to provide a resource to the user device 102 over one or more paths associated with networks 210, 220, 230, 240. A path may comprise one or more nodes (e.g., xNB 212, UPF 214, access point 222, gateway 224). A path may comprise any quantity of nodes and two paths may be distinct if any one of those nodes does not exist in the other path.

A filter 250 (e.g., content filter, resource filter) may be implemented to restrict access to one or more resources. A resource may be located in the cloud 260, Internet, application server 270, otherwise, or combinations thereof. A resource may be indicated by name, number, link, content, otherwise, or combinations thereof. For example, a resource may be a universal resource link (URL). A resource may comprise content (e.g., audio, video) or may be associated with content. A resource may also be an appliance, virtual, hardware, or otherwise. For example, the resource filter may scan the resource once received and accept or reject the resource. For example, the user device 102 may be attempting to access a URL that is listed as banned on a register or content may be received that is scanned, categorically, and banned based on the categorization.

The filter 250 may receive a policy from the policy distributor 262. A policy may include a list of rules of allowed resources that may include URLs, content categories, or otherwise. A policy distributor 262 may receive the policy from a policy creator 264. The filter 250 may be an access point to the cloud 260 or Internet, providing access to application server 270.

As shown in FIG. 2, traffic traverses each network 210, 220, 230, 240 to a single filter 250. The policy is created and controlled by the policy creator 264 by configuring a policy distributor 262. The policy distributor 262 then sends the appropriate content filtering configuration to the filter 250. The configuration commands sent to filter 250 to implement the content filtering policy may be device dependent.

The convergence of user traffic across the networks 210, 220, 230, 240 into a single path that reaches the single filter 250 can be achieved based on 3GPP standards work as specified in 3GPP TS 23.501. More specifically, the Principle Mobile Network 210 and Supplemental Radio Access Network 240 can be 3GPP 5G networks. The user traffic across Mobile Networks 210 and 240 can interconnect by selecting the UPF in the Principle Mobile Network 210 for users requiring content filtering. The Public Hotspot 220 can interconnect with the Principle Mobile Network 210 using Non-3GPP Interworking Function (N3IWF) or Trusted Non-3GPP Gateway Function (TNGF). The Home or Work network 230 can interconnect with the Principle Mobile Network 20 using Wireline Access Gateway Function (W-AGF).

In the Principle Mobile Network 210, traffic steering control may use activate and deactivate steering policies from the policy control function (PCF) to the session management function (SMF) for the purpose of steering the user's traffic to the appropriate filter 250 in or after (as depicted) the user plane function (UPF).

FIG. 3 shows an example communication path 300 in accordance with one or more implementations of the present disclosure. The communication path 300 may include one or more nodes (e.g., xNB 212, gateway 224) associated with one or more networks 210, 220, 230, 240. The user device 102 includes instructions for executing a client application 302. The user device 102 may further include instructions for a multipath connection 304. A multipath connection 304 may be based on multipath Transmission Control Protocol (MPTCP), multipath QUIC (MPQUIC), multipath Datagram Congestion Control Protocol (MPDCCP), another multipath protocol, or a combination thereof. An identifier may be assigned to designate the multipath connection 304. The multipath connection 304 may include two subflows 306, 310. The subflows 306, 310 may be identified based on a subflow sequence number. For example, the sequence numbers may be used to reassemble data sent over the multipath connection 304. For example, a data sequence mapping may be used to assemble data received over the path and data received over the path. For example, the path may comprise nodes or hops from network 210 (e.g., xNB 212, UPF 214) and the path may comprise nodes or hops from network 220. Each subflow may have an individual IP address 308, 312.

The multipath connection 304 may terminate at a transport converter 380. The transport converter 380 may be based on a 0-RTT protocol (e.g., Internet Engineering Task Force (IETF) request for comment (RFC) 8803). The transport converter 380 may be configured to convert the multipath connection 304 into a single path connection 352. The transport converter 380 may serve as a proxy between the user device 102 and communications over multiple paths and subflows 306, 310. The single path connection 352 may terminate at a server application 356 providing the resource. For example, the single path connection 352 may terminate at the application server 270.

The filter 250 may receive the policy from the policy distributor 262, the policy creator 264, or otherwise, and the filter 250 may reject communications from either the user device 102 or the server application 356. For example, the filter 250 may reject data from one or more of the multiple paths and subflows 306, 310 or reject data from the single path connection 352. For example, the filter 250 may take the assembled data from the user device 102 or assemble the data from the user device 102 and scan a request or transmission for compliance with the policy. The policy may be based on one or more of the networks that the multiple paths and subflows 306, 310 traversed. For example, the filter 250 may apply one filter to data received over the first subflow 306 and a different policy for data receive over subflow 310. Blocking data in such a way from traversing one of the paths may cause an auto-transfer to one of the other data paths based on the policy. For example, some policies can be generic for all of the networks 210, 220, 230, 240 and some policies may be tailored to a specific network 210, 220, 230, 240. For example, the policy may include operational parameters or traffic steering parameters that filter to adjust one or more of the subflows 306, 310. The policy may be based on the source of the data, based on the network, based on the resource, based on a content or content parameter, or combinations thereof.

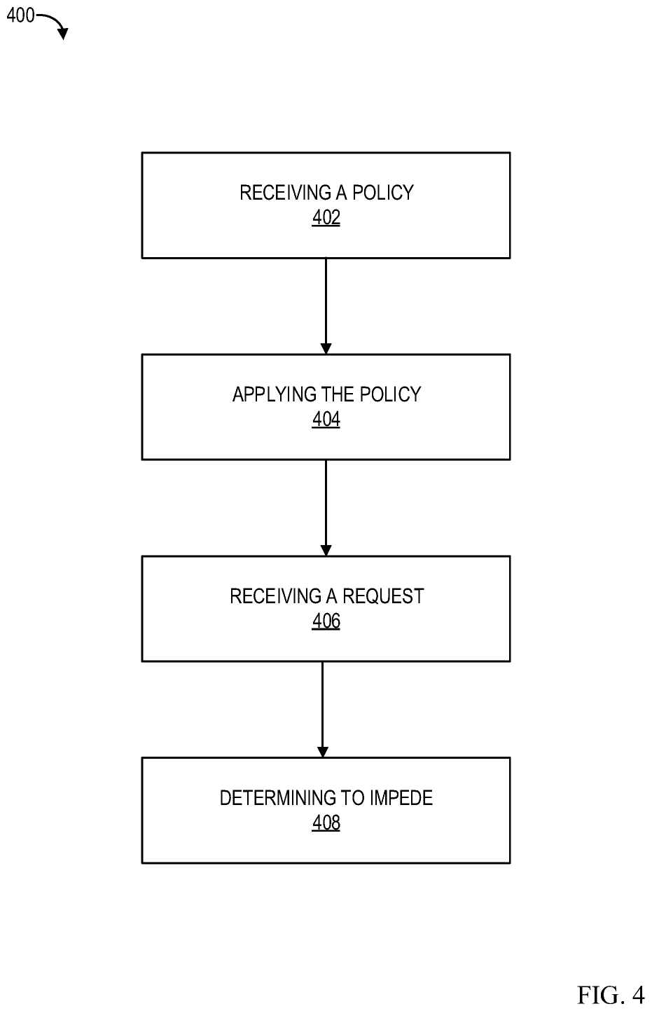

FIG. 4 shows an example method 400 in accordance with one or more implementations of the present disclosure. The method 400 may be implemented by any of the devices (e.g., user device 102, transport converter 380, application server 270, filter 250) described herein. In step 402, the method may include receiving a policy for filtration services. For example, the policy may include a list or repository of resources that are blocked (e.g., content types, resource types). The policy may be received from the policy distributor 262. The policy may be received over one or more of the networks 210, 220, 230, 240 or the cloud 260. The policy may be based on one or more of the networks 210, 220, 230, 240. For example, a policy may be configured to block resources on one network and allow resources on another network. Further, the policy may be configured to block resources on one network that are based on a subflow and allow resources that are not based on a subflow.

In step 404, a network appliance (e.g., filter 250) or node may be configured to apply the policy to one or more networks 210, 220, 230, 240 or one or more paths that traverse those networks 210, 220, 230, 240. For example, application of the policy may include blocking a resource, impeding a resource, quarantining resource. Application of the policy may also include providing an indication that the resource should be accessed on a different path or network 210, 220, 230, 240. For example, a resource may be detected and blocked from traversing network 210 and an indication of the blocked resource may be sent to the application server 270 or the user device 102.

In step 406, the user device 102 or application server 270 may request the resource over another path or network 220, 230, 240. The received request may be a first request or a subsequent request for the resource. For example, the request may be the first request for the resource over one of the networks 210, 220, 230, 240 and a subsequent request may be received for the resource over another of the networks 210, 220, 230, 240. The request may be forwarded to an application server 270 or another resource to fulfill the request. For example, a network node may evaluate the request and forward the request to retrieve the resource. After receiving the resource, the network node may forward the resource to the user device 102.

A connection may be formed or determined between the user device 102 and the transport converter 380 or another network appliance. For example, the connection may be based on an identifier for multipath communications. The identifier may be used to assemble or disassemble packets, requests, data, or resources for sending or receiving over the subflows 306, 310. For example, the request may be assembled by the transport converter 380 or another appliance and sent to the application server 270 or sent to retrieve other resources. Assembling the request may be based on a data sequence mapping and a first subflow sequence number of the first subflow 306 and a second subflow sequence number of the second subflow 310. Upon receipt of the resource, the resource may be disassembled. Dissassembling the resource may be based on a data sequence mapping and a first subflow sequence number of the first subflow 306 and a second subflow sequence number of the second subflow 310.

In step 408, the resource may be determined to be restricted based on the policy, and forwarding of the resource may be impeded. For example, the packet or resource may be dropped, block, quarantined, otherwise prevented from reaching its destination, or a combination thereof.

Nodes of the first path and the second path may be located on other networks 210, 220, 230, 240. For example, a node of a path predominantly on network 220 may also include an interworking function 216 that is on either the network 220 or the network 210. Network nodes may be security edge protection proxies 218, interworking functions 216, user plane functions 214, or other hops and network appliances.

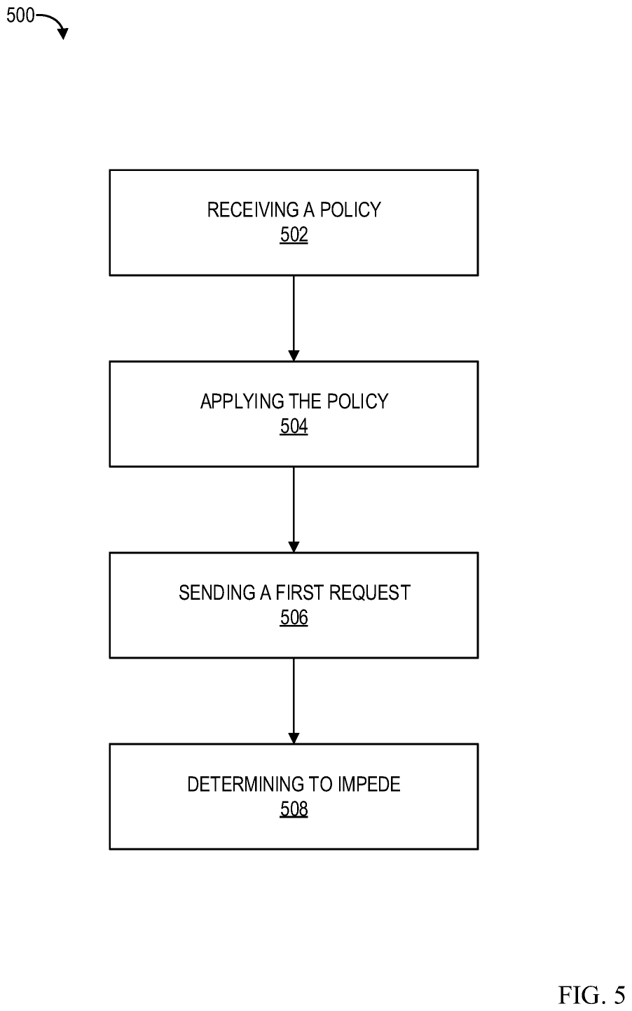

FIG. 5 shows an example method 500 in accordance with one or more implementations of the present disclosure. The method 500 may be implemented by any of the devices (e.g., user device 102, transport converter 380, application server 270, filter 250) described herein. In step 502, the method may include receiving a policy for filtration services. For example, the policy may include a list or repository of resources that are blocked (e.g., content types, resource types). The policy may be received from the policy distributor 262. The policy may be received by the user device 102. The policy may be received over one or more of the networks 210, 220, 230, 240 or the cloud 260. The policy may be based on one or more of the networks 210, 220, 230, 240. For example, a policy may be configured to block resources on one network and allow resources on another network. Further, the policy may be configured to block resources on one network that are based on a subflow and allow resources that are not based on a subflow.

In step 404, a device (e.g., user device 102) or node may be configured to apply the policy to one or more networks 210, 220, 230, 240 or one or more paths that traverse those networks 210, 220, 230, 240. For example, application of the policy may include one or more of blocking a resource, impeding a resource, or quarantining resource. Application of the policy may also include providing an indication that the resource should be accessed on a different path or network 210, 220, 230, 240. For example, a resource may be detected and blocked from traversing network 210 and an indication of the blocked resource may be sent to the application server 270 or the user device 102.

In step 406, the user device 102 or application server 270 may send a request for the resource over another path or network 220, 230, 240. For example, the client application 302 may request a resource that is restricted by the policy. The request may be intended to be sent over the first path or the second path or a combination thereof according to subflows 306, 310. The sent request may be a first request or a subsequent request for the resource. The request may be the first request for the resource over one of the networks 210, 220, 230, 240 and a subsequent request may be received for the resource over another of the networks 210, 220, 230, 240. For example, the user device 102 may evaluate the request and forward the request to retrieve the resource. After receiving the resource, the user device may forward the resource to the client application 302.

A connection may be formed or determined between the user device 102 and the transport converter 380 or another network appliance. For example, the connection may be based on an identifier for multipath communications. The identifier may be used to assemble or disassemble packets, requests, data, or resources for sending or receiving over the subflows 306, 310. For example, the request may be assembled by the transport converter 380 or another appliance and sent to the application server 270 or sent to retrieve other resources. Assembling the request may be based on a data sequence mapping and a first subflow sequence number of the first subflow 306 and a second subflow sequence number of the second subflow 310. Upon receipt of the resource, the resource may be disassembled. Disassembling the resource may be based on a data sequence mapping and a first subflow sequence number of the first subflow 306 and a second subflow sequence number of the second subflow 310.

In step 408, the resource may be determined to be restricted based on the policy and forwarding of the resource may be impeded. For example, the packet or resource may be dropped, blocked, quarantined, otherwise prevented from reaching its destination, or a combination thereof.

Nodes of the first path and the second path may be located on other networks 210, 220, 230, 240. For example, a node of a path predominantly on network 220 may also include an interworking function 216 that is on either the network 220 or the network 210. Network nodes may be security edge protection proxies 218, interworking functions 216, user plane functions 214, or other hops and network appliances.

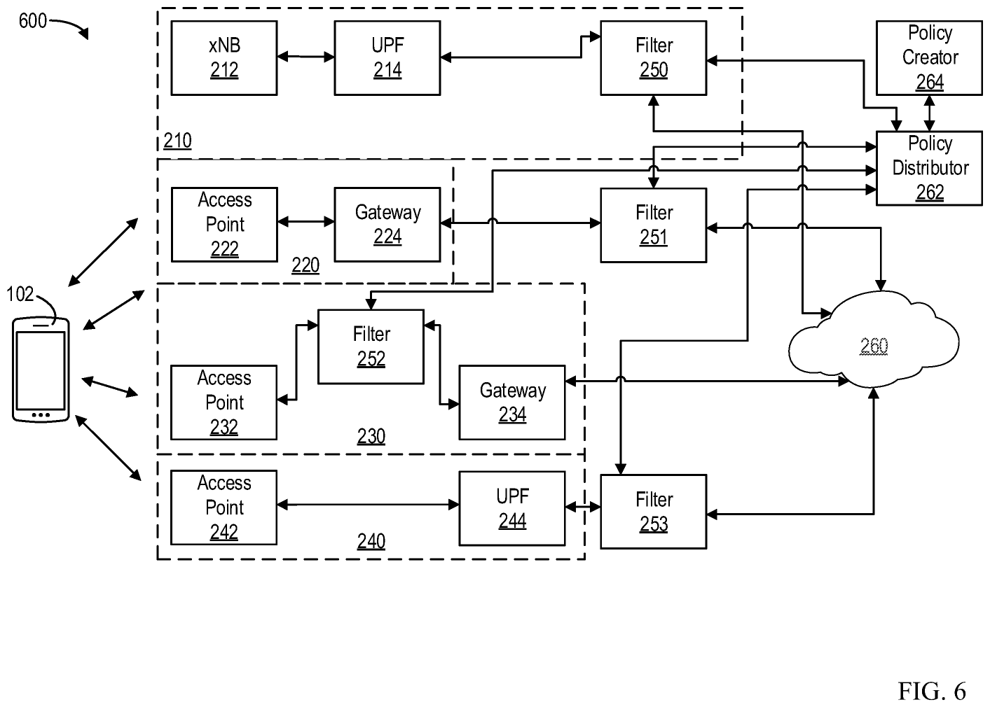

FIG. 6 shows an example architecture 600 in accordance with one or more implementations of the present disclosure. As shown in FIG. 6, each of the networks 210, 220, 230, 240 have their own filter 250, 251, 252, 253 that filters the accessible resources (e.g., cloud 260). The filters 250, 251, 252, 253 may receive respective policies from the policy distributor 262. The policies may be specific to, or based on, the connected network 210, 220, 230, 240. Each access technology (e.g., 5G, Wi-Fi) or access provider may receive a policy that is specific to the given technology. The configuration commands sent to filters 250, 251, 252, 253 to implement the policy may be device dependent.

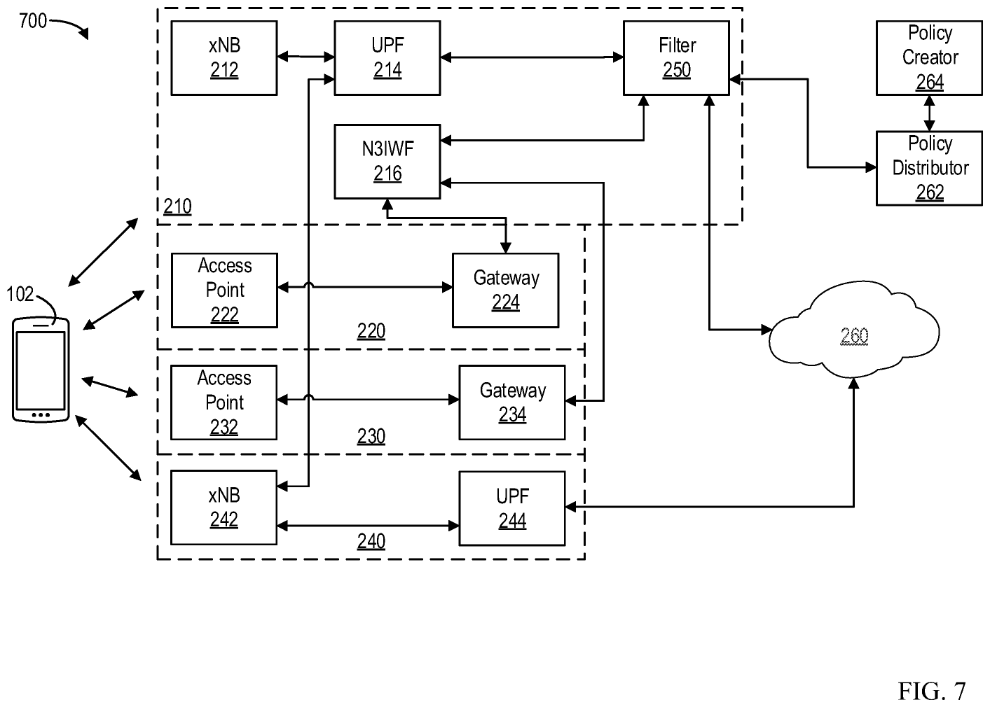

FIG. 7 shows an example architecture 700 in accordance with one or more implementations of the present disclosure. As shown in FIG. 6, user traffic traverses each access network 210, 220, 230, 240 to a single filter 250. The content filtering policy may be created and controlled by the policy creator 264 by configuring a policy distributor 262. The policy distributor 262 may then send the appropriate content filtering configuration to the filter 250. The configuration commands sent to filter 250 to implement the content filtering policy may be device dependent.

The convergence of user traffic across the four access networks 210, 220, 230, 240 into a single path that reaches the single filter 250 can be achieved based on 3GPP standards work as specified in 3GPP TS 23.501 et al. More specifically, the Principle Mobile Network 210 and Supplemental Radio Access Network 240 can be 3GPP 5G networks. The user traffic across Mobile Networks 210, 240 can interconnect by selecting the UPF in the Principle Mobile Network for users requiring content filtering. The public access point 222 can interconnect with the Principle Mobile Network 210 using N3IWF or TNGF. The network 230 can interconnect with the Principle Mobile Network 210 using W-AGF.

In the Principle Mobile Network 210, traffic steering control may be used to activate and deactivate steering policies from the PCF to the SMF for the purpose of steering the user's traffic to the appropriate filter 250 in or after (as depicted) the UPF.

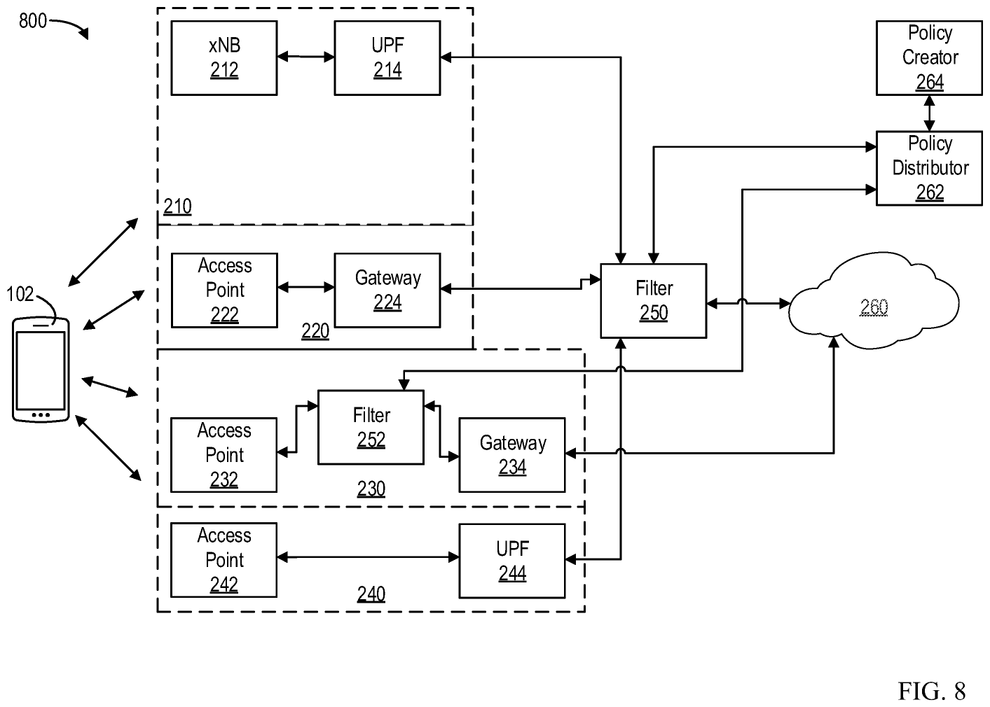

FIG. 8 shows an example architecture 800 in accordance with one or more implementations of the present disclosure. As shown in FIG. 8, user traffic traverses public networks 210, 220, 240 to filter 250 and user private network 230 to filter 252. The policy may be created and controlled by the Policy Creator 264 by configuring a Policy distributor 262. The policy distributor 262 may then send the appropriate content filtering configuration to the corresponding filters 250, 252. The configuration commands sent to filters 250, 252 to implement the content filtering policy may be device dependent.

The convergence of user traffic across the three public networks 210, 220, 240 to filter 250 can be achieved based on routing for the Public Access Point 222 and 3GPP standards work as specified in 3GPP TS 23.501 et al. for networks 210, 240. Specifically, the Principle Mobile Network 210 and Supplemental Mobile Network 240 can be 3GPP 5G networks. The user traffic subject to content filtering across Networks 210, 240 can be steered to the filter 250 located near the public gateway 224. The public gateway 224 can be configured to route user traffic directly to the filter 250. For network 230, content filtering may be performed on (as depicted) or after the home or business wireless access gateway 234 located on the customer's premises.

In the networks 210, 240, traffic steering control may be used to activate and deactivate steering policies from the PCF to the SMF for the purpose of steering the user's traffic to the filter 250. The filter 250 may be part of the network 220 or separately located and accessible to one or more of networks 210, 220, 230, 240. Interfaces may be used (e.g., N9, Nx) to connect user plane functions (e.g., UPF 214, UPF 244) and other nodes of the networks 210, 220, 230, 240. For example, the filter 250 may be provisioned on a cloud-computing server accessible over the Internet.

The user device 102 may perform the filtering before traffic traverses the various access networks 210, 220, 230, 240. The policy may be created and controlled by the Policy Creator 264 by configuring a Policy distributor 262. The policy distributor 262 may then send the appropriate content filtering configuration to the corresponding filter 250 on the user device 102. The configuration commands sent to the filter 250 on the user device 102 to implement the content filtering policy may be device dependent.

The policy creator 264 may send the corresponding content filtering commands to the filters (e.g., filter 250) directly instead of to the policy distributor 262 for subsequent distribution. The configuration commands sent to the filters for implementing the content filtering policy may be device dependent.

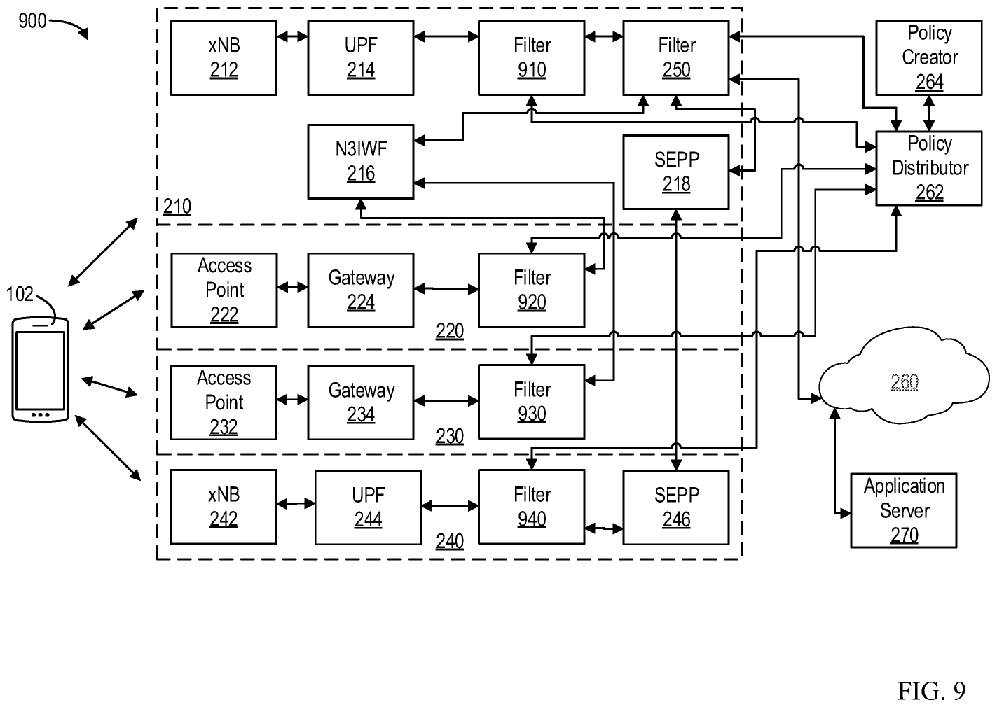

FIG. 9 shows an example architecture 900 in accordance with one or more implementations of the present disclosure. The architecture 900 may include various access networks (e.g., networks 210, 220, 230, 240). As described with regard to FIG. 2, a network 210 (e.g., a network of a first network operator) may include wireless communication protocols between the user device 102 and the cellular base station 212 (e.g., eNB, gNB, xNB). A network may maintain the radio access network and the associated core network, which may include the user plane function 214, network interworking function 216, security edge protection proxy 218, and other components.

The operator of network 210 may issue subscriptions for the user device 102 to access the network 210. The network 210 may include a network-specific filter (e.g., filter 910). The network-specific filter may be a pre-filter. The network specific filter may receive a policy tailored to network 210. For example, the policy tailored to network 210 may be unique with regard to policies for the other networks (e.g., networks 220, 230, 240). For example, the policy may be tailored based on a location of the cellular base station 212, other attributes associated with the network 210, or attributes of network 210 relative to networks 220, 230, 240.

Another communication path may be established between the user device 102 and the computing device 122 over a network 220 (e.g., a network of a second network operator or a different access node of the first network operator) having a Wi-Fi or IEEE 802.11 access point 222. The access point 222 may be configured to communicate with a wireless access gateway 224. The wireless access gateway 224 may route data packets from the access point 224 to the network 210. An operator of the network 220 may maintain the access point 222 and the associated wireless access gateway 224. The network may issue subscriptions for the user device 102 to access one or more of the networks (e.g., network 210, 220, 230, 240).

The wireless access gateway 234 and the wireless access gateway 224 may be configured to directly communicate over an interface. For example, an access and mobility function (AMF), or user plane function (UPF) may perform some or all of the steps described herein. The wireless access gateways 224, 234 may provide the user device 102 with internet access through an interworking function (e.g., network interworking function 216). Networks 220, 230 may further include respective filters 920, 930. The respective filters 920, 930 may be specifically tailored to the respective networks 220, 230. For example, the filters 920, 930 may restrict access to resources based on policies. The policies may be unique to the respective networks 220, 230 or filters 920, 930. The computing device 122 may be configured to perform all or some of the steps described. For example, the computing device 122 may filter resources accessible by the user device 102.

Additional networks 230, 240 may be available to the user device 102. The network 230 may be similar to that of network 220, wherein the network 230 may include an access point 232 and a gateway 234. For example, the network 220 may be public network accessible to user devices 102 having a subscription to access the network, while the network 230 may be a home network accessible to user devices 102 within an effective range of the access point 232. The access point 222 may be implemented unitarily with the access point 232 in that they have a common housing, transceiver, or other component in common. Network 240 may be similar to that of network 210, wherein the network 240 may include a base station 242 and user plane function 244. Internetwork communications may be performed between SEPP 218 and SEPP 246. The network 240 may include a respective filter 940. The filter 940 may receive a unique policy (e.g., unique with respect to policies for filters 910, 920, 930).

The computing device 122 may be associated or integrated with one or more of the networks 210, 220, 230, 240. The computing device 122 may be independent of the networks 210, 220, 230, 240 and may be disposed on another network or the cloud. For example, the computing device 122 may serve as an intermediary, receiving data from the user device 102 over any of the networks 210, 220, 230, 240 or another network and restricting access to one or more resources otherwise available.

The computing device 122 may include instructions to serve as a proxy or proxy server (e.g., an MPTCP proxy, an MPDCCP proxy, an MPQUIC proxy) for the plurality of paths formed between application server 270 and user device 102. For example, one or more application servers 270 may be configured to provide a resource to the user device 102 over one or more paths associated with networks 210, 220, 230, 240. A path may comprise one or more nodes (e.g., xNB 212, UPF 214, access point 222, gateway 224). A path may comprise any quantity of nodes and two paths may be distinct if any one of those nodes does not exist in the other path.

A filter 250 (e.g., content filter, resource filter) may be implemented to restrict access to one or more resources in addition to the resources restricted by the network-specific filters 910, 920, 930, 940. For example, a network-specific filter (e.g., filter 910) may allow access to a resource and filter 250 may deny or inhibit access to a resource or vice-versa. A resource may be located in the cloud 260, Internet, application server 270, or combinations thereof. A resource may be indicated by name, number, link, content, or combinations thereof. For example, a resource may be a universal resource link (URL). A resource may be content (e.g., audio, video) or associated with content. A resource may also be an appliance, virtual, hardware, or otherwise. For example, the resource filter may scan the resource once received and accept or reject the resource. For example, the user device 102 may be attempting to access a URL that is listed as banned on a register or content may be received that is scanned, categorically, and banned based on the categorization.

The filter 250 may receive a policy from the policy distributor 262. A policy may include a list of rules of allowed resources that may include URLs, content categories, or otherwise. A policy distributor 262 may receive the policy from a policy creator 264. The filter 250 may be an access point to the cloud 260 or Internet, providing access to application server 270.

As shown in FIG. 9, traffic traverses each network 210, 220, 230, 240 and filters 910, 920, 930, 940 to a single filter 250. The policy is created and controlled by the policy creator 264 by configuring a policy distributor 262. The policy distributor 262 then sends the appropriate content filtering configuration to the filter 250. The configuration commands sent to the filter 250 to implement the content filtering policy may be device dependent.

The convergence of user traffic across the networks 210, 220, 230, 240 into a single path that reaches the single filter 250 can be achieved based on 3GPP standards (e.g., 3GPP TS 23.501). Specifically, the Principle Mobile Network 210 and Supplemental Radio Access Network 240 can be 3GPP 5G networks. The user traffic across Mobile Networks 210 and 240 can interconnect by selecting the UPF in the Principle Mobile Network 210 for users requiring content filtering. The Public Hotspot 220 can interconnect with the Principle Mobile Network 210 using Non-3GPP Interworking Function (N3IWF) or Trusted Non-3GPP Gateway Function (TNGF). The Home or Work network 230 can interconnect with the Principle Mobile Network 210 using Wireline Access Gateway Function (W-AGF).

In the Principle Mobile Network 210, traffic steering control may be used to activate and deactivate steering policies from the policy control function (PCF) to the session management function (SMF) for the purpose of steering the user's traffic to the appropriate filter 250 in or after (as depicted) the user plane function (UPF).

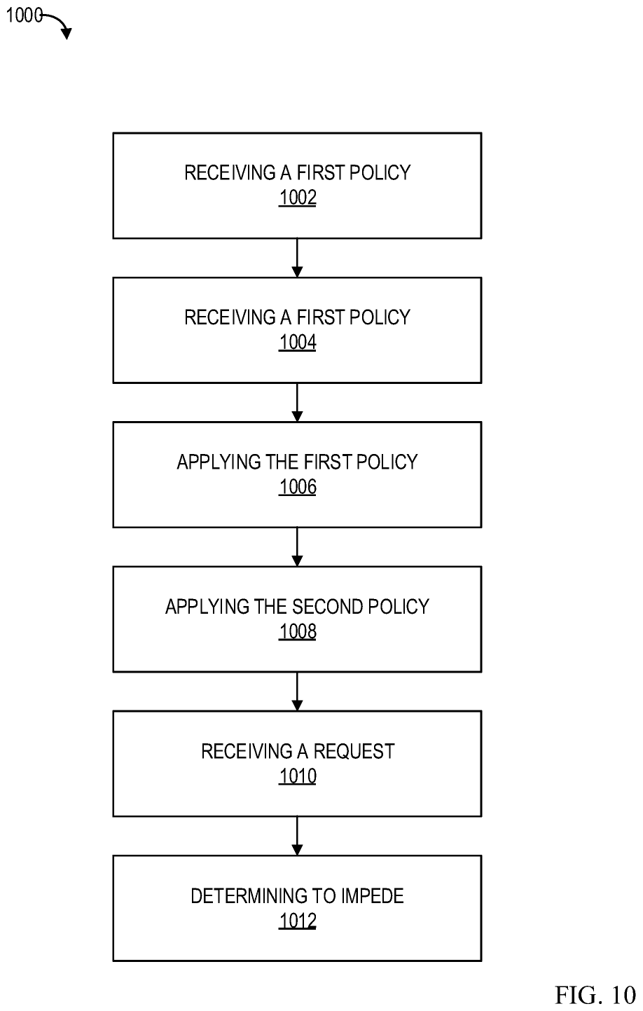

FIG. 10 shows an example method 1000 in accordance with one or more implementations of the present disclosure. The method 1000 may be implemented with respect to one or more of the networks 210, 220, 230, 240. The method 1000 may be performed by any of the devices (e.g., user device 102, transport converter 380, application server 270, filter 250) described herein. In step 1002, the method 1000 may include receiving a first policy for filtration services. For example, the first policy may include a list or repository of resources that are blocked (e.g., content types, resource types). The first policy may be received from the policy distributor 262. The first policy may be received by the user device 102. For example, the first policy may be received over one or more of the networks 210, 220, 230, 240 or the cloud 260. The first policy may be based on one or more of the networks 210, 220, 230, 240. For example, a policy may be configured to block resources on one network and allow resources on another network. Further, the first policy may be configured to block resources on one network that are based on a subflow and allow resources that are not based on a subflow.

In step 1004, a device (e.g., user device 102) or node may be configured to apply the first policy to one or more networks 210, 220, 230, 240 or one or more paths that traverse those networks 210, 220, 230, 240. For example, application of the policy may include one or more of blocking a resource, impeding a resource, or quarantining a resource. Application of the policy may also include providing an indication that the resource should be accessed on a different path or network 210, 220, 230, 240. For example, a resource may be detected and blocked from traversing network 210 and an indication of the blocked resource may be sent to the application server 270 or the user device 102.

In step 1006, the method may include receiving a second policy for filtration services. For example, the second policy may include a list or repository of resources that are blocked (e.g., content types, resource types). The second policy may be received from the policy distributor 262. The second policy may be received by the user device 102. The second policy may be received over one or more of the networks 210, 220, 230, 240 or the cloud 260. The second policy may be based on one or more of the networks 210, 220, 230, 240. For example, a policy may be configured to block resources on one network and allow resources on another network. Further, the second policy may be configured to block resources on one network that are based on a subflow and allow resources that are not based on a subflow. The second policy may be different from the first policy. For example, the second policy may impede access to different resources than the first policy. The second policy may be associated with a different key from the first policy.

In step 1008, a device (e.g., user device 102) or node may be configured to apply the second policy to one or more networks 210, 220, 230, 240 or one or more paths that traverse those networks 210, 220, 230, 240. For example, application of the policy may include one or more of blocking a resource, impeding a resource, or quarantining a resource. Application of the policy may also include providing an indication that the resource should be accessed on a different path or network 210, 220, 230, 240. For example, a resource may be detected and blocked from traversing network 210 and an indication of the blocked resource may be sent to the application server 270 or the user device 102.

In step 1010, the user device 102 or application server 270 may send a request for the resource over another path or network 220, 230, 240. For example, the client application 302 may request a resource that is restricted by the policy. The request may be intended to be sent over the first path or the second path or a combination thereof according to subflows 306, 310.

The sent request may be a first request or a subsequent request for the resource. The request may be the first request for the resource over one of the networks 210, 220, 230, 240 and a subsequent request may be received for the resource over another of the networks 210, 220, 230, 240. For example, the user device 102 may evaluate the request and forward the request to retrieve the resource. After receiving the resource, the user device 102 may forward the resource to the client application 302. The request, or the resource, may be available over multiple paths. For example, the first path may traverse a first filter (e.g., filter 910) and the second path may traverse a second filter (e.g., filter 920). The request or access to the resource may traverse one or more of the paths. For example, the request or the access to the resource may be disassembled or assembled at the user device 102 or the application server 270.

In step 1012, access to the resource may be impeded. For example, the first resource may be impeded by one or of filters 910, 920, 930, 940, 250. For example, the application of the first policy or the application of the second policy may cause one or of the filters 910, 920, 930, 940, 250 to block the resource from the user device 102 or the application server 270.

The method 1000 may include receiving a third policy for filtration services. For example, the third policy may include a list or repository of resources that are blocked (e.g., content types, resource types). The third policy may be received from the policy distributor 262. The third policy may be received by the user device 102. The third policy may be received over one or more of the networks 210, 220, 230, 240 or the cloud 260. The third policy may be based on one or more of the networks 210, 220, 230, 240. For example, a policy may be configured to block resources on one network and allow resources on another network. Further, the third policy may be configured to block resources on one network that are based on a subflow and allow resources that are not based on a subflow.

A device (e.g., user device 102) or node may be configured to apply the third policy to one or more networks 210, 220, 230, 240 or one or more paths that traverse those networks 210, 220, 230, 240. For example, application of the policy may include one or more of blocking a resource, impeding a resource, or quarantining a resource. Application of the policy may also include providing an indication that the resource should be accessed on a different path or network 210, 220, 230, 240. For example, a resource may be detected and blocked from traversing network 210 and an indication of the blocked resource may be sent to the application server 270 or the user device 102.

The third policy may be applied at the global filter (e.g., filter 250). For example, the third policy may impede access to the resource when the first policy and second policy would otherwise allow access to the resource.

The network functions described herein may be generally referred to as a generic combination function that may run on one or more servers, one or more instances, one or more sets of instructions, and so on. Such instances may be containerized, replicated, scaled, and distributed by network 210, 220, 230, 240 to meet the growing demands of respective networks. Any of the steps or functions described in one or more of the methods, architectures, or call flows described herein may be used in conjunction with any of the other methods, architectures, or call flows described herein. Any of the components (e.g., network functions, user equipment, servers) may perform any of the steps from any of the methods or call flows described herein even though not specifically described and may be performed in combination with any of the other components. It should be appreciated that the techniques described herein relate to various protocols and technology and may at least apply to 3G, LTE, and 5G technologies.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims

What is claimed is:

1. A method comprising:
receiving a policy for filtration of resources;
applying the policy to a first path comprising a first network and a second path comprising a second network;
receiving, from a user device and based on the first path, a first request for a first resource; and
determining, based on the first resource and the application of the policy, to impede access to the first resource.

2. The method of claim 1, wherein the policy is applied to a connection comprising a first subflow over the first path and a second subflow over the second path.

3. The method of claim 2, further comprising assembling the first request based on a data sequence mapping and a first subflow sequence number of the first subflow and a second subflow sequence number of the second subflow.

4. The method of claim 2, further comprising disassembling the first resource based on a data sequence mapping and a first subflow sequence number of the first subflow and a second subflow sequence number of the second subflow.

5. The method of claim 1, wherein the first network comprises a first node and the second network comprises a second node, and the first path comprises the second node.

6. The method of claim 5, wherein the first node comprises one or more of a security edge protection proxy, a user plane function, or an interworking function.

7. The method of claim 1, wherein the first network comprises a user plane function and the first request traverses the user plane function.

8. The method of claim 1, wherein the second network comprises an interworking function and the first request traverses the interworking function.

9. A method comprising:
receiving a policy for filtration of resources;
applying the policy to a first path comprising a first network and a second path comprising a second network;
sending, based on the first path, a first request for a first resource; and
determining, based on the first resource and the application of the policy, to impede access to the first resource.

10. The method of claim 9, wherein the first network comprises a first node and the second network comprises a second node, and the first path comprises the second node.

11. The method of claim 10, wherein the first node comprises one or more of a security edge protection proxy, a user plane function, or an interworking function.

12. The method of claim 10, wherein the first path comprises the second node and the second path comprises the second node.

13. The method of claim 9, wherein the first network comprises a user plane function and the first request traverses the user plane function.

14. The method of claim 9, wherein the second network comprises an interworking function and the first request traverses the interworking function.

15. A method comprising:
receiving a first policy for filtration of resources;
receiving a second policy for the filtration of resources;
applying the first policy to a first path comprising a first network;
applying the second policy to a second path comprising a second network;
receiving, based on the first path and the second path, a first request for a first resource; and
determining, based on the first resource and the application of the first policy and the application of the second policy, to impede access to the first resource.

16. The method of claim 15, wherein at least one of the first policy or the second policy is applied to a connection comprising a first subflow over the first path and a second subflow over the second path.

17. The method of claim 16, further comprising assembling the first request based on a data sequence mapping and a first subflow sequence number of the first subflow and a second subflow sequence number of the second subflow.

18. The method of claim 16, further comprising disassembling the first resource based on a data sequence mapping and a first subflow sequence number of the first subflow and a second subflow sequence number of the second subflow.

19. The method of claim 15, wherein the first network comprises a first node and the second network comprises a second node, and the first path comprises the second node.

20. The method of claim 19, wherein the first node comprises one or more of a security edge protection proxy, a user plane function, or an interworking function.
